(19) United States
(12) Patent Application Publication
(10) Pub. No.: US 2006/0109804 A1
(43) Pub. Date: May 25, 2006

(54) System for parallel transmission over WLAN and method therefor

(75) Inventors: Hao-Li Wang, Taipei City (TW); Zi-Tsan Chou, Taipei City (TW); Kuo-Hwa Wu, Yonghe City (TW); Lee-Jen Lu, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/028,521

(22) Filed: Jan. 5, 2005

(30) Foreign Application Priority Data
Nov. 23, 2004 (TW) 093135968

(51) Int. Cl. H04Q 7/00

(52) U.S. Cl. 370/278; 370/329

(57) ABSTRACT

Provided is a system for parallel transmission over WLAN and method therefor. The method comprises causing a first mobile station to transmit an RTS and causing a second mobile station to transmit a CTS after receiving the RTS; searching third mobile stations to find any one receiving the RTS not the CTS and taking it as transmitting terminal; after receiving the CTS causing the first mobile station to transmit a first fragmentation to the second mobile station, after receiving the first fragmentation causing the second mobile station to reply to the first mobile station with an ACK, and repeatedly causing the first mobile station to transmit a next fragmentation until the fragmentations have been transmitted; and causing the transmitting terminal to transmit an RTS to a receiving terminal when the first mobile station is transmitting, and causing the receiving terminal to transmit a CTS after the second mobile station replying to the first mobile station with the ACK.

### BACKGROUND OF THE INVENTION

1. Field of the Invention

The present invention relates to a wireless local area network (WLAN) and, more particularly, to a system for parallel transmission over a WLAN and a method therefor.

2. Description of Related Art

The existing IEEE 802.11 standard for a WLAN was published in 1997. In the IEEE 802.11 standard, physical layer (PHY) and medium access control (MAC) operations are defined. However, many research reports and test results indicate that 802.11 MAC has a poor performance. One important reason is the exposed node problem.

As shown in FIG. 1, in the existing IEEE 802.11 standard, a mobile station's channel access right is preserved by RTS/CTS exchange. In a service area covered by mobile stations A and B, mobile station A transmits a request to send (RTS) signal when mobile station A intends to transmit data to mobile station B. After receiving the RTS, mobile station B transmits a clear to send (CTS) signal to mobile station A. After receiving the CTS, mobile station A transmits a data frame to mobile station B. After receiving the data frame, mobile station B replies to mobile station A with an acknowledgement (ACK). By carrying out the RTS/CTS exchange, mobile stations near to mobile stations A and B can be informed of the intended data transmission. Thereafter, data transmission between mobile stations A and B can begin without being interrupted. Now, it is assumed that mobile station P in a service area of mobile station A is intended to transmit data to mobile station Q in which mobile station P is not in a service area of mobile station B, and mobile station Q is not in a service area common to both mobile stations A and B. After mobile station P has received an RTS issued by mobile station A, mobile station P will transmit data only after mobile station A has finished its data transmission. Likewise, a mobile station's channel access right is preserved by an RTS/CTS exchange. Mobile station P then can transmit a data frame to mobile station Q. Data transmission between mobile stations A and B and data transmission between mobile stations P and Q cannot occur simultaneously. However, data transmission from mobile station A to mobile station B and data transmission from mobile station P to mobile station Q can occur simultaneously in the real environment. This is because mobile station Q is not in a service area of mobile station A and thus mobile station Q is interfered by mobile station A. Likewise, mobile station B is not in a service area of mobile station P and thus mobile station B is interfered by mobile station P. As such, data transmission from mobile station A to mobile station B and data transmission from mobile station P to mobile station Q can occur simultaneously in the real environment. Such prohibition by IEEE 802.11 is called the exposed node problem. The exposed node problem limits a number of data transmissions to one transmission at one time, resulting in a decrease of channel reuse ratio and network performance. Thus, a need for improvement exists.

### SUMMARY OF THE INVENTION

An object of the present invention is to provide a system for parallel transmission over a WLAN and a method therefor so as to carry out a simultaneous data transmission, solve the exposed node problem, greatly increase a channel reuse ratio, and increase the WLAN system performance.

One aspect of the present invention is to provide, in a WLAN system including a first mobile station, a second mobile station, and a plurality of third mobile stations wherein the first and second mobile stations are capable of communicating with each other, a method for parallel transmission comprising the steps of, in an RTS/CTS exchange stage of MT causing the first mobile station to transmit a RTS and causing the second mobile station to transmit a CTS in response to receiving the RTS; in a mobile station finding stage searching the third mobile stations to find one or more mobile stations receiving the RTS not the CTS and taking each of the one or more mobile stations as a transmitting terminal for a subsequent parallel transmission; in a data transmission stage of MT in response to receiving the CTS causing the first mobile station to transmit a first one of a plurality of fragmentations to the second mobile station, in response to receiving the first fragmentation causing the second mobile station to reply to the first mobile station with an ACK, and repeatedly causing the first mobile station to transmit a next one of the fragmentations until all of the fragmentations have been transmitted; and in an RTS/CTS exchange stage of ST causing the transmitting terminal for the parallel transmission to transmit an RTS to a corresponding receiving terminal when the first mobile station is transmitting the fragmentation, and causing the receiving terminal to transmit a CTS in response to the second mobile station replying to the first mobile station with an ACK such that the MT and the ST are made synchronous, wherein the fragmentations are of the same length.

Another aspect of the present invention is to provide a system for parallel transmission over a WLAN comprising a first assembly comprising a first mobile station and a second mobile station wherein the first and second mobile stations are capable of communicating with each other in an MT, and wherein the first mobile station is adapted to transmit an RTS, the second mobile station is adapted to transmit a CTS in response to receiving the RTS, in response to receiving the CTS the first mobile station is adapted to transmit a first one of a plurality of fragmentations to the second mobile station, in response to receiving the first fragmentation the second mobile station is adapted to reply to the first mobile station with an ACK, and the first mobile station is adapted to repeatedly transmit a next one of the fragmentations until all of the fragmentations have been transmitted; and a second assembly comprising a third mobile station and a fourth mobile station wherein the third and fourth mobile stations are capable of communicating with each other in an ST, the third mobile station is in a service area of the first mobile station not in a service area of the second mobile station, and the fourth mobile station is not in the service area of the first mobile station, wherein the third mobile station is adapted to transmit an RTS to the fourth mobile station when the first mobile station is transmitting the fragmentation, and the fourth mobile station is adapted to transmit a CTS in response to the second mobile station replying to the first mobile station with an ACK such that the MT and the ST are made synchronous, and wherein the fragmentations are of the same length.

Other objects, advantages, and novel features of the invention will become more apparent from the detailed description when taken in conjunction with the accompanying drawings.

### BRIEF DESCRIPTION OF THE DRAWINGS

FIG. 1 illustrates a WLAN system operating in accordance with the existing IEEE 802.11 standard for preserving a mobile station's channel access right by an RTS/CTS exchange;

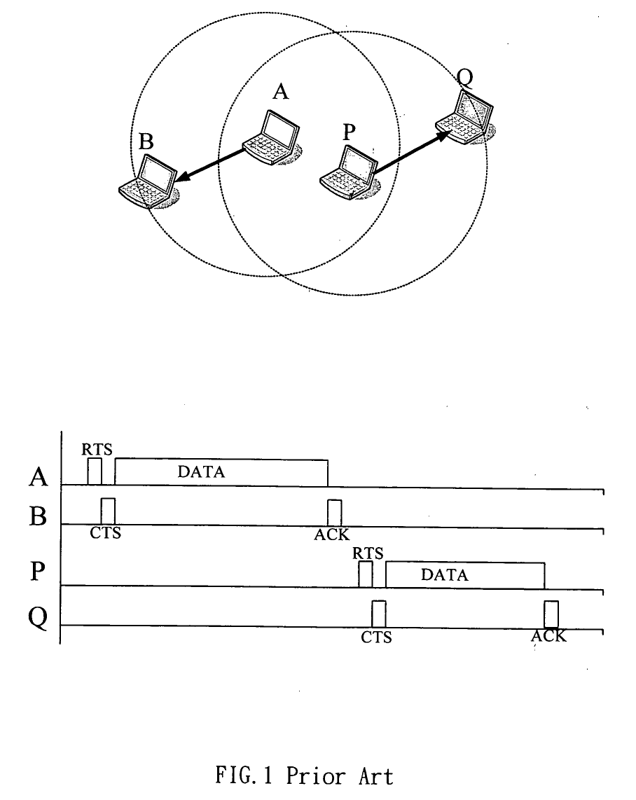

FIG. 2 illustrates a method of the invention for finding mobile stations capable of performing a parallel transmission;

FIG. 3 illustrates a WLAN system operating in accordance with a first preferred embodiment of the invention for parallel transmission;

FIG. 4 presents a feasible signaling in the method of the invention for carrying out parallel transmission over a WLAN; and

FIG. 5 illustrates a WLAN system operating in accordance with a second preferred embodiment of the invention for parallel transmission.

### DETAILED DESCRIPTION OF THE PREFERRED EMBODIMENT

The invention is directed to a system for parallel transmission over a WLAN and a method therefor so as to solve the exposed node problem and carry out a simultaneous data transmission. The method involves a mobile station finding stage and a subsequent parallel transmission. For the mobile station finding stage, two or more mobile stations for future parallel transmission are searched. For the subsequent parallel transmission, it is carried out by an RTS/CTS exchange such that a number of mobile stations are able to transmit or receive data simultaneously.

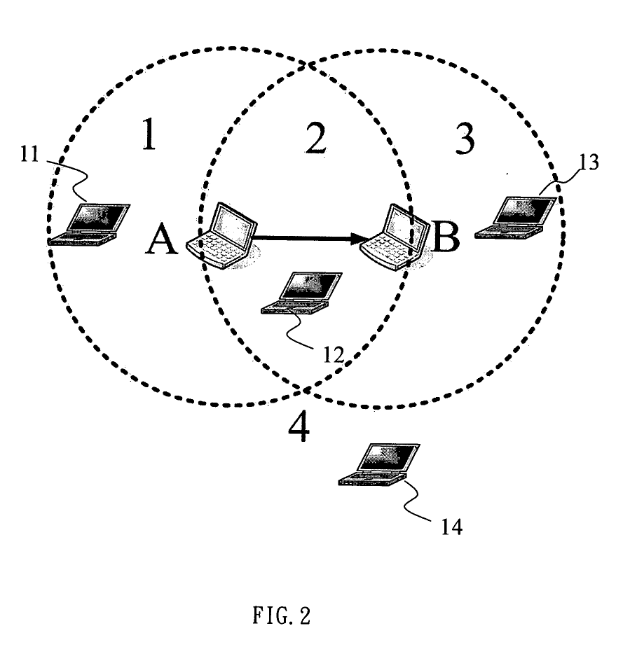

With reference to FIG. 2, details of the mobile station finding stage are shown. It is assumed that data is transmitting from mobile station A to mobile station B. Potential mobile stations capable of transmitting or receiving data simultaneous with the data transmission from mobile station A to mobile station B can be found by analyzing an RTS sent by mobile station A and CTS sent by mobile station B as received by other mobile stations.

As shown, mobile station 11 receiving the RTS means that mobile station 11 is in a service area (e.g., area 1) of mobile station A not in a service area of mobile station B. At this time, mobile station 11 is allowed to transmit data without interfering with data transmitted from mobile station A to mobile station B. Mobile station 12 receiving the RTS and CTS means that mobile station 12 is in a service area (e.g., area 2) of mobile station A not in a service area of mobile station B. At this time, mobile station 12 is not allowed to transmit or receive data since it may interfere with data transmitted from mobile station A to mobile station B.

Mobile station 13 receiving a CTS means that mobile station 13 is in a service area (e.g., area 3) of mobile station B not in a service area of mobile station A. At this time, mobile station 13 is allowed to receive data without interfering with data transmitted from mobile station A to mobile station B. Mobile station 14 not receiving an RTS and CTS means that mobile station 14 is neither in a service area of mobile station A nor in a service area (e.g., area 4) of mobile station B. At this time, mobile station 14 is allowed to transmit or receive data since it may not interfere with data transmitted from mobile station A to mobile station B.

In view of the above analysis, it is found that among other mobile stations only mobile station 11 receiving an RTS can be a transmitting terminal capable of carrying out a simultaneous transmission and only mobile station 11 receiving a CTS can be a receiving terminal capable of carrying out a simultaneous receiving when mobile station A (i.e., transmitting terminal) is transmitting data to mobile station B (i.e., receiving terminal).

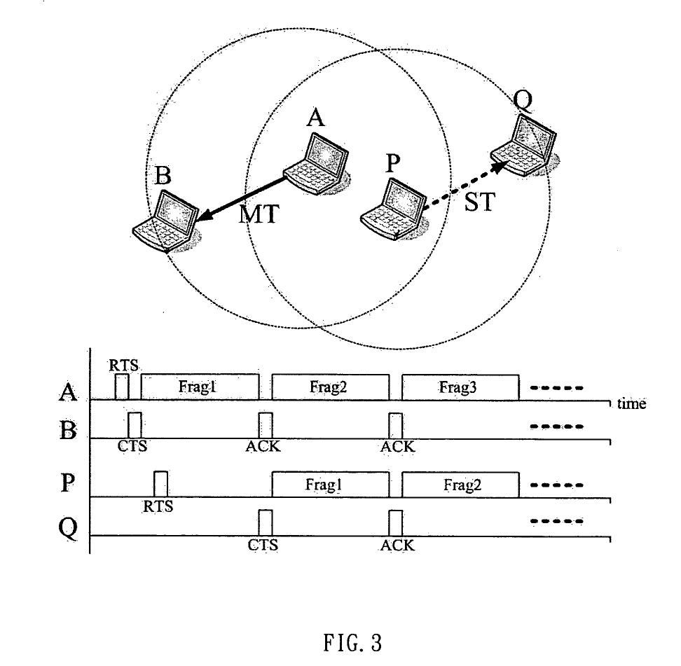

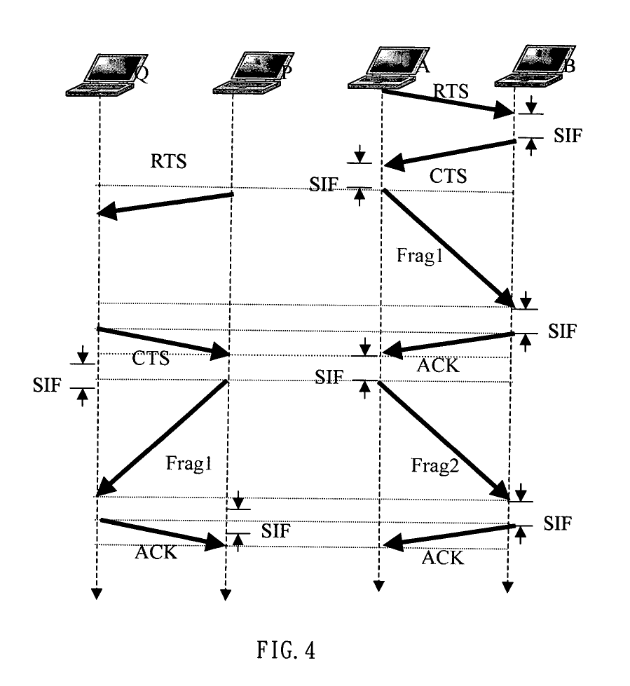

With reference to FIGS. 3 and 4, details of the subsequent parallel transmission are shown. An initial data transmission (e.g., from mobile station A to mobile station B) is called master transmission (MT). Any subsequent data transmissions are called slave transmissions (STs) and they attempt to be simultaneous with MT. Similar to existing IEEE 802.11, an RTS/CTS exchange is performed prior to MT. That is, mobile station A first transmits an RTS. After receiving the RTS, mobile station B will wait a short inter frame (SIF) of time prior to transmitting a CTS. After receiving the CTS, mobile station A will wait a SIF of time prior to transmitting data to mobile station B. Data is comprised of a plurality of fragmentations. For example, mobile station A first transmits a first fragmentation (e.g., frag1). After receiving frag1, mobile station B will wait a SIF of time prior to replying to mobile station A with an ACK. After receiving the ACK, mobile station A will wait a SIF of time prior to transmitting a second fragmentation (e.g., frag2). After receiving frag2, mobile station B will wait a SIF of time prior to replying to mobile station A with an ACK. The above steps will continue until all fragmentations have been transmitted by mobile station A.

In the above RTS/CTS exchange with respect to MT, one of nearby mobile stations (e.g., mobile station P) decides its next step in MT based on received the RTS or CTS. For example, in the above mobile station finding stage, a mobile station receiving the RTS not the CTS can be a potential transmitting terminal capable of carrying out a simultaneous transmission. Alternatively, a mobile station receiving the CTS not the RTS can be a potential receiving terminal capable of carrying out a simultaneous receiving. A mobile station as a potential transmitting terminal capable of carrying out a simultaneous transmission (e.g., mobile station P) is required to establish a connection to a receiving terminal (e.g., mobile station Q). Thus, mobile station P transmits an RTS to a target receiving terminal (e.g., mobile station Q not in a service area of mobile station A) while a first fragmentation (e.g., frag1 in FIG. 3) is transmitting in the MT. Rather than transmitting a CTS within a SIF of time, mobile station Q transmits a CTS only when a receiving terminal (e.g., mobile station B) is transmitting an ACK in the MT. As a result, a potential interference between the MT and the ST is avoided.

After mobile station Q replies with the CTS, the ST is aware that it is simultaneous with the MT. Next, mobile station P is allowed to transmit data to mobile station Q. Likewise, data is comprised of a plurality of fragmentations. For example, mobile station P first transmits a first fragmentation (e.g., frag1). After receiving frag1, mobile station Q will wait a SIF of time prior to replying to mobile station P with an ACK. After receiving the ACK, mobile station P will wait a SIF of time prior to transmitting a second fragmentation (e.g., frag2). After receiving frag2, mobile station Q will wait a SIF of time prior to replying to mobile station P with an ACK. The above steps will continue until all fragmentations have been transmitted by mobile station P. A potential interference between MT and ST is avoided (i.e., parallel transmission made possible) since all fragmentations have the same length.

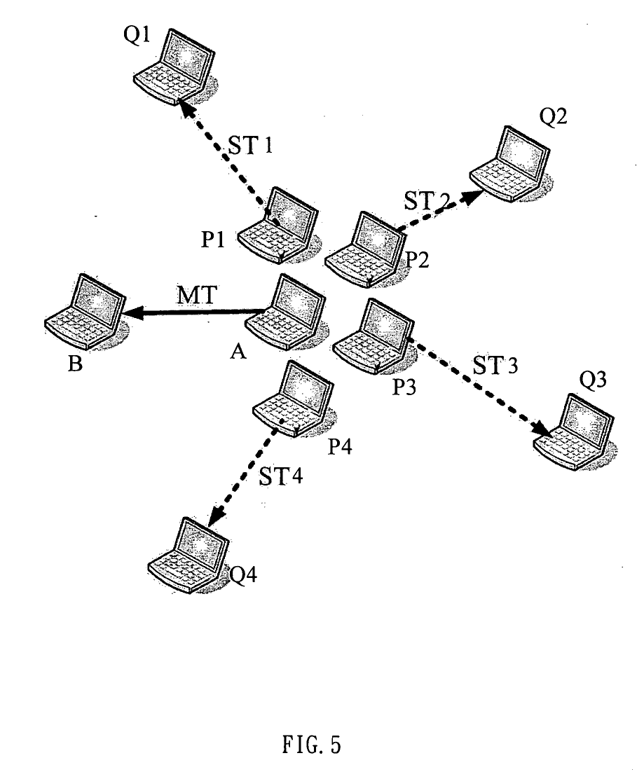

With reference to FIG. 5, there is illustrated a WLAN system operating in accordance with a second preferred embodiment of the invention for parallel transmission. As shown, one MT and a plurality of STs (e.g., ST1, ST2, ST3, and ST4) are performed simultaneously. Similar to the first embodiment, a receiving terminal (e.g., mobile station P1, P2, P3, or P4) of an ST (e.g., ST1, ST2, ST3, or ST4) transmits an RTS to a target receiving terminal (e.g., mobile station Q1, Q2, Q3, or A4) while an MT is transmitting a first fragmentation. The receiving terminal (e.g., mobile station Q1, Q2, Q3, or A4) transmits a CTS only when a receiving terminal (e.g., mobile station B) is transmitting an ACK in the MT. As an end, a potential interference between the MT and any of the STs (e.g., ST1, ST2, ST3, or ST4) is avoided.

While the invention herein disclosed has been described by means of specific embodiments, numerous modifications and variations could be made thereto by those skilled in the art without departing from the scope and spirit of the invention set forth in the claims.

What is claimed is:

1. In a WLAN system including a first mobile station, a second mobile station, and a plurality of third mobile stations wherein the first and second mobile stations are capable of communicating with each other, a method for parallel transmission comprising the steps of:
in an RTS/CTS exchange stage of an MT causing the first mobile station to transmit an RTS and causing the second mobile station to transmit a CTS in response to receiving the RTS;
in a mobile station finding stage searching the third mobile stations to find one or more mobile stations receiving the RTS not the CTS and taking each of the one or more mobile stations as a transmitting terminal for a subsequent parallel transmission;
in a data transmission stage of the MT in response to receiving the CTS causing the first mobile station to transmit a first one of a plurality of fragmentations to the second mobile station, in response to receiving the first fragmentation causing the second mobile station to reply to the first mobile station with an ACK, and repeatedly causing the first mobile station to transmit a next one of the fragmentations until all of the fragmentations have been transmitted; and
in an RTS/CTS exchange stage of the ST causing the transmitting terminal for the parallel transmission to transmit an RTS to a corresponding receiving terminal when the first mobile station is transmitting the fragmentation, and causing the receiving terminal to transmit a CTS in response to the second mobile station replying to the first mobile station with the ACK such that the MT and the ST are made synchronous, wherein the fragmentations are of the same length.

2. The method of claim 1, further comprising steps of in a data transmission stage of an ST in response to receiving the CTS by the transmitting terminal causing the transmitting terminal to transmit a first one of the plurality of fragmentations to the receiving terminal, in response to receiving the first fragmentation causing the receiving terminal to reply to the transmitting terminal with an ACK, and repeatedly causing the transmitting terminal to transmit a next one of the fragmentations until all of the fragmentations have been transmitted.

3. A system for parallel transmission over a WLAN comprising:
a first assembly comprising a first mobile station and a second mobile station wherein the first and second mobile stations are capable of communicating with each other in an MT, and wherein the first mobile station is adapted to transmit an RTS, the second mobile station is adapted to transmit a CTS in response to receiving the RTS, in response to receiving the CTS the first mobile station is adapted to transmit a first one of a plurality of fragmentations to the second mobile station, in response to receiving the first fragmentation the second mobile station is adapted to reply to the first mobile station with an ACK, and the first mobile station is adapted to repeatedly transmit a next one of the fragmentations until all of the fragmentations have been transmitted; and
a second assembly comprising a third mobile station and a fourth mobile station wherein the third and fourth mobile stations are capable of communicating with each other in an ST, the third mobile station is in a service area of the first mobile station not in a service area of the second mobile station, and the fourth mobile station is not in the service area of the first mobile station, wherein the third mobile station is adapted to transmit an RTS to the fourth mobile station when the first mobile station is transmitting the fragmentation, and the fourth mobile station is adapted to transmit a CTS in response to the second mobile station replying to the first mobile station with the ACK such that the MT and the ST are made synchronous, and wherein the fragmentations are of the same length.

4. The system of claim 3, wherein in response to receiving the CTS by the third mobile station the third mobile station is adapted to transmit the first fragmentation to the fourth mobile station, in response to receiving the first fragmentation the fourth mobile station is adapted to reply to the third mobile station with an ACK, and the third mobile station is adapted to repeatedly transmit a next one of the fragmentations until all of the fragmentations have been transmitted.
